(19) United States
(12) Patent Application Publication
(10) Pub. No.: US 2004/0163414 A1
(43) Pub. Date: Aug. 26, 2004

(54) Method of processing a glass substrate for a magnetic disk and method of manufacturing the glass substrate

(75) Inventors: Nobuyuki Eto, Tokyo (JP); Hideki Isono, Amphur Muang (TH)

Correspondence Address: SUGHRUE MION, PLLC, 2100 PENNSYLVANIA AVENUE, N.W., SUITE 800, WASHINGTON, DC, 20037, US

(73) Assignees: HOYA CORPORATION; HOYA GLASS DISK (THAILAND) LTD.

(21) Appl. No.: 10/777,680

(22) Filed: Feb. 13, 2004

(30) Foreign Application Priority Data
Feb. 20, 2003 (JP) 43212/2003

(51) Int. Cl. C03C 15/00

(52) U.S. Cl. 65/30.14

(57) ABSTRACT

In a method of processing a glass substrate for a magnetic disk, the glass substrate containing alkali ions, the glass substrate is processed by the use of a first alkali ion having a first ion radius greater than the smallest ion radius of the smallest alkali ion among the alkali ions contained the glass substrate. Subsequently, the glass substrate is processed by the use of a second alkali ion having a second ion radius greater than the first ion radius of the first alkali ion.

This application claims priority to prior Japanese application JP 2003-43212, the disclosure of which is incorporated herein by reference.

### BACKGROUND OF THE INVENTION

This invention relates to a method of processing or treating glass substrate which is suitably used for a magnetic disk to be mounted in a magnetic disk apparatus such as a hard disk drive, and to a method of manufacturing the glass substrate.

As a substrate for a magnetic disk of the type described, use is typically made of an aluminum substrate, a polycarbonate substrate, and a glass substrate. Among these substrates, the glass substrate high in flatness and smoothness and in rigidity is preferably used as a disk substrate for a hard disk drive (hereinafter, will be abbreviated to “HDD”), which is required to achieve a high recording density. In the HDD, a magnetic head flies and travels at a narrow flying height over the magnetic disk which rotates at a high speed so that an information recording/reproducing (read/write) operation is carried out for the magnetic disk. Therefore, the substrate for the magnetic disk is required to be high in shock or impact resistance and mechanical strength. It is noted here that the glass substrate has high rigidity on one hand but itself is a fragile material on the other hand. For this reason, from the viewpoint for improving the shock resistance, it is attempted to improve surface strength of the glass substrate.

For example, in case where the glass substrate is used as the substrate for the magnetic disk, the surface of the glass substrate is often subjected to a chemical strengthening process using an ion exchange method (at a low temperature) in order to improve the shock resistance or vibration resistance and to prevent the glass substrate from being damaged or broken by mechanical impact or shock, vibration, and so on.

In thechemical strengthening process, for example, Li ions and Na ions constituting the surface of the glass substrate are replaced via ion exchange by Na ions and K ions greater in ion radius than Li ions and Na ions, respectively. By this replacement, strong compression stress is caused to occur on the surface of the glass substrate so as to enhance the mechanical strength of the glass substrate. Such chemical strengthening process of the glass substrate is proposed, for example, in Japanese Patent Application Publication (JP-A) No. 7-230621. In the above-mentioned publication, the glass substrate is chemically strengthened by replacing Na ions of the surface of the glass substrate by K ions of potassium nitrate salt. Besides, it is also proposed to process the glass substrate by the use of a mixed salt of potassium nitrate salt and sodium nitrate salt instead of the potassium nitrate alone.

Following rapid development of the IT (Information Technology) society in recent years, the magnetic disk is dramatically improved to have a higher recording density and a smaller size. In particular, with development of a ubiquitous technique, the demand for a mobile HDDis rapidly increased. Further, there is an increasing demand for a low cost. As described above, the glass substrate is preferable as the disk substrate for use in the HDD. However, in case of a thin glass substrate suitable for such mobile HDD application,it has been found out that, even when the chemical strengthening process is carried out, predetermined compression stress may not be obtained on the surface of the glass substrate and that a tensile stress inside the glass substrate may become excessively large.

If the compression stress of the surface of the glass substrate is small, the shock resistance of the glass substrate becomes low. As a consequence, the glass substrate may be broken in the mobile application. On the other hand, if the tensile stress inside the glass substrate is excessively large, the glass substrate is decreased in mechanical strength and may be easily broken with lapse of time.

Under the circumstances, in case where glass substrates are mass- produced by using the conventional chemical strengthening process, the individual glass substrates thus produced are significantly varied in transverse strength. Therefore, even if the glass substrates are attempted to be mass- produced, a defect rate is high and a production cost is increased. As a consequence, it is difficult to manufacture the glass substrate for the magnetic disk at a low cost.

### SUMMARY OF THE INVENTION

It is therefore an object of this invention to provide a method of processing a glass substrate suitable for a magnetic disk to be mounted in a magnetic disk apparatus such as HDD, which is high in transverse strength and is prevented from damage or breakage with time.

It is another object of this invention to provide a method of manufacturing the above-mentioned glass substrate.

The present inventors carried out a chemical strengthening process for a glass substrate by the use of various processing agents. As a result, it has been found out that, in order to provide the glass substrate with high transverse strength and durability against damage with time, a stress profile given by the above-mentioned process must be appropriately controlled from the surface of the substrate towards the inside thereof in dependence upon a thickness of the glass substrate. Based on the finding, further study has been made of the relationship between the processing agents used for the substrate and each of the stress profile given to the substrate, the high transverse strength, and the durability against the damage with time. As a result of the study, the present inventors invented a processing method performed upon manufacturing the glass substrate for the magnetic disk so as to make the glass substrate exhibit stable strength.

According to a first aspect of this invention, there is provided a method of processing a glass substrate for a magnetic disk, the glass substrate containing alkali ions, the method comprising the steps of processing the glass substrate by the use of a first alkali ion having a first ion radius greater than the smallest ion radius of the smallest alkali ion among the alkali ions contained in the glass substrate; and subsequently processing the glass substrate by the use of a second alkali ion having a second ion radius greater than the first ion radius of the first alkali ion.

The glass substrate processed according to the method in the first aspect of this invention is given high transverse strength and durability against damage with time.

According to a second aspect of this invention, a first molten salt containing sodium nitrate is used as a first processing agent for supplying the first alkali ion while a second molten salt containing potassium nitrate is used as a second processing agent for supplying the second alkali ion.

In the second aspect of this invention, the first molten salt containing sodium nitrate can be suitably used as the first processing agent for supplying the first alkali ion while the second molten salt containing potassium nitrate can be suitably used as the second processing agent for supplying the second alkali ion.

According to a third aspect of this invention, the glass substrate is made of a glass containing 58-75 weight % SiO₂, 5-23 weight % Al₂O₃, 3-10 weight % Li₂O, and 4-13 weight % Na₂O.

The glass substrate having the structure in the third aspect of this invention is given high transverse strength and durability against damage with time after the the glass substrate is processed as mentioned above.

According to a fourth aspect of this invention, the glass substrate has a thickness within a range of 0.6 mm or less.

Even if the glass substrate for the magnetic disk has the thickness within the range of 0.6 mm or less as specified in the fourth aspect of this invention, the glass substrate is given the high transverse strength and the durability against damage with time.

According to a fifth aspect of this invention, a method of manufacturing the glass substrate includes the processing method according to the first aspect of this invention.

In the fifth aspect of this invention, by manufacturing the glass substrate by using the manufacturing method including the processing method according to the first aspect of this invention, the magnetic disk having the high transverse strength and the durability against damage with time can be obtained

According to a sixth aspect of this invention, in a method of manufacturing a magnetic disk, at least a magnetic layer is formed on the glass substrate produced by the method in the fifth aspect of this invention.

By the method in the sixth aspect of this invention, the magnetic disk having high transverse strength and durability against damage with time can be obtained.

### DESCRIPTION OF THE PREFERRED EMBODIMENT

Now, description will be made of a process performed upon manufacturing a glass substrate for a magnetic disk (hereinafter, will simply be referred to as a glass substrate) according to an embodiment of this invention.

At first, a glass substrate containing, for example, lithium ions as alkali ions having the smallest ion radius is prepared. Then, a first-stage process for the glass substrate is carried out by using a processing agent containing first alkali ions (such as sodium ions) greater in ion radius than the alkali ions (lithium ions) contained in the glass substrate and having the smallest ion radius.

In the first-stage process, the alkali ions (lithium ions) contained in the glass substrate and having the smallest ion radius are ion-exchanged with the first alkali ions (sodium ions) contained in the processing agent and having a greater ion radius. As a result, compression stress is caused to occur on the surface of the glass substrate. Further, the aforementioned first alkali ions permeate towards the inside of the glass substrate so that a compression stress layer is formed also inside the glass substrate. In this event, tensile stress is produced in the depth of the glass substrate so as to counteract the compression stress of the compression stress layer inside the glass substrate and to keep a balance with the compression stress.

Successively, the glass substrate is subjected to a second-stage process by using a processing agent containing second alkali ions (for example, potassium ions) greater in ion radius than the above-mentioned first alkali ions.

Also in this event, by a mechanism similar to that in the first-stage process, the lithium ions or the sodium ions contained in the glass substrate are ion-exchanged with the second alkali ions (potassium ions). As a result, the compression stress is produced on the surface of the glass substrate or in a layer near the surface while the tensile stress is produced in the depth of the glass substrate. However, the second alkali ions are greater in ion radius than the first alkali ions and hardly permeate into the glass substrate. Therefore, the compression stress produced on the surface of the glass substrate or in the layer near the surface by the second alkali ions has a value greater than that of the compression stress generated by the first alkali ions. However, the thickness of the compression stress layer formed in the second-stage process is smaller than that obtained in the first-stage process.

In each of the first and the second-stage processes for the glass substrate, the compression stress is produced and the compression stress layer is formed on the surface of the glass substrate and inside the glass substrate while the tensile stress is produced in the depth of the glass substrate. By monitoring the value of the compression stress, the film thickness of the compression stress layer, and the value of the tensile stress and appropriately controlling processing conditions of the first-stage and the second-stage processes for the glass substrate, it is possible to control the stress profile from the surface of the glass substrate towards the inside thereof. If desired, a third-stage and a fourth-stage process may be performed.

Thus, it is possible to set the stress profile in conformity with physical conditions required for the glass substrate to be processed. As a result, it is possible to obtain the glass substrate exhibiting high transverse strength and durability against damage with time although the thickness is small, as required in the glass substrate for a magnetic disk. Further, the first-stage and the second-stage processes and so on for the glass substrate are industrially stable and, therefore, precise control is possible. In addition, it is possible to obtain the glass substrate having stable quality with high yield even upon mass-production. As a consequence, the production cost can be reduced.

Next, description will be made of the relationship between each of the above-mentioned glass substrate, a variety of processing agents, and the process conditions, and the physical conditions of the glass substrate resulting from the stress profile given to the glass substrate. In addition, description will be made of production of the magnetic disk using the glass substrate manufactured through the above-described processes and having desired physical conditions.

Glass Substrate

As the glass for use as the glass substrate according to this invention, an amorphous aluminosilicate glass may advantageously be used. Such an aluminosilicate glass can precisely exhibit or obtain a desired level of the compression stress, a desired thickness of the compression stress layer, and a desired level of the tensile stress by an ion exchange chemical strengthening method, in particular, a low-temperature ion exchange chemical strengthening method so that the effect of this invention can advantageously be achieved. The aluminosilicate glass desirably contains alkali ions, in particular, lithium ions. The aluminosilicate glass of the type preferably has a composition of 58-75 weight % SiO₂, 5-23 weight % Al₂O₃, 3-10 weight % Li₂O, and 4-13 weight % Na₂O.

More preferably, the glass substrate is made of an aluminosilicate glass essentially consisting of 62-75 weight % SiO₂, 5-15 weight % Al₂O₃, 4-10 weight % Li₂O, 4-12 weight % Na₂O, and 5.5-15 weight % ZrO₂ with the weight ratio of Na₂O/ZrO₂ falling within a range of 0.5-2.0 and the weight ratio of Al₂O₃/ZrO₂ falling within a range of 0.4-2.5.

Further, in order to prevent occurrence of projections formed on the surface of the glass substrate resulting from an undissolved portion of ZrO₂, use is preferably made of a glass essentially consisting of 57-74 mol % SiO₂, 0-2.8 mol % ZrO₂, 3-15 mol % Al₂O₃, 7-16 mol % Li₂O, and 4-14 weight % Na₂O.

The above-mentioned aluminosilcate glass is increased in transverse strength and improved in Knoop hardness through the chemical strengthening process.

The thickness of the glass substrate according to this invention is not particularly restricted. However, the thickness of the glass substrate preferably falls within a range of 0.2 mm-0.9 mm, more preferably within a range of 0.2 mm-0.6 mm, in order to suitably obtain the effect of this invention. According to this invention, even when the thickness of the glass substrate is so thin as described above, it is possible to economically and stably supply the suitable glass substrate exhibiting the high transverse strength and the durability against the damage with time.

The shape of the glass substrate is not specifically restricted but may be selected from various shapes. In particular, the magnetic disk having a smaller diameter than that of a 2.5 inch type disk, namely, the magnetic disk having a diameter not greater than 65 mm suitably exhibits the effect of this invention. Especially, the magnetic disk having such a small diameter is very useful for a mobile HDD.

The glass substrate according to this invention preferably has a mirror-polished surface prior to the chemical strengthening process. As the mirror-polished surface, the principal surface of the glass substrate preferably has Rmax within a range of 6 nm or less and Ra within a range of 0.6 nm or less while an end face of the glass substrate preferably has Rmax within a range of 0.01-1 μm and Ra within a range of 0.001-0.8 μm. When the glass substrate after mirror-polishing is subjected to the chemical strengthening process. the chemical strengthening process can be uniformly carried out without causing any nonuniformity even in a microscopic region on the surface of the glass substrate. Herein, the surface roughness Rmax is a maximum height representative of a difference between a highest point and a lowest point of the surface and the surface roughness Ra is an arithmetic average roughness or the center-line-mean roughness as defined in Japanese Industrial Standard JIS B0601 and disclosed in U.S. Pat. No. 6,544,893B2.

Processing Agents

In this invention, as an example of the processing agent for the chemical strengthening process using the aforementioned first alkali ions, molten salt containing sodium nitrate as a major component (hereinafter will simply be referred to as “sodium nitrate”) is used. On the other hand, as an example of the processing agent for the chemical strengthening process using the aforementioned second alkali ions, molten salt containing potassium nitrate as a major component (hereinafter will simply be referred to as “potassium nitrate”) is used. As regards the case where sodium nitrate and potassium nitrate are used as the processing agents, the embodiment of this invention will further be described.

By the chemical strengthening process using the sodium nitrate, a thick compression stress layer can be formed inside the processed glass substrate. Therefore, even if a deep crack is formed in the glass substrate, the mechanical strength of the glass substrate can be advantageously kept. Further, since the compression stress layer is thick, the glass substrate after the chemical strengthening process is suppressed in strength variation, thus obtaining a stable quality. However, from the viewpoint that the processed glass substrate is used as a magnetic disk for HDD, especially, for mobile HDD, the compression stress produced on the surface of the glass substrate often has an insufficient value. Furthermore, as a trade-off of the thick compression stress layer as the advantage of this invention, the tensile stress generated in the depth of the glass substrate problematically becomes excessively large. In particular, in case where the glass substrate is thin, the problem that the tensile stress inside the glass substrate tends to be increased is prominent. In order to solve these problems, the present inventors studied about applying another process to the glass substrate in addition to the process using sodium nitrate.

On the other hand, the chemical strengthening process using potassium nitrate is advantageous in that the large compression stress can be generated on the surface of the processed glass substrate and, therefore, the shock resistance of the glass substrate can be increased. Further, since the compression stress layer is thin, the value of the tensile stress generated in the depth of the glass substrate can be advantageously reduced.

However, because of the thin compression stress layer, the strength variation among the processed glass substrates becomes large upon mass production. Under the circumstances, it is supposed that additional means is necessary in order to stabilize the quality of the obtained glass substrate.

According to this invention, a combination of the process using sodium nitrate and the process using potassium nitrate makes it possible not only to compensate the disadvantages of and utilize the advantages of both of the processes but also to precisely control an appropriate internal stress profile inside the glass substrate. As a result, even when the glass substrate is thin, it is possible to obtain high durability and high strength and to manufacture the glass substrate having a stable quality at a low cost.

Processing Method

In this invention, in case where the process is carried out by the use of sodium nitrate, the molten salt preferably contains 60-100 weight % sodium nitrate. Inclusion of 60-100 weight % sodium nitrate can suitably achieve the effect of this invention.

Further, in this invention, in case where the process is carried out by the use of potassium nitrate, the molten salt preferably contains 60-100 weight % potassium nitrate. Inclusion of 60-100 weight % potassium nitrate can suitably achieve the effect of this invention.

In this invention, it is preferable that, upon carrying out the chemical strengthening process, lithium ions are added to the aforementioned molten salt so as to widen a control range of the stress profile. As a method of adding the lithium ions, it is preferable to add lithium nitrate to the above-mentioned molten salt.

A method of carrying out the chemical strengthening process according to this invention is not particularly restricted but any known method may be used. By way of example, the ion-exchange method will hereinafter be explained.

In the ion exchange method, the glass substrate is contacted with the molten salt of the heated processing agent to thereby exchange ions in the surface layer of the glass substrate with the ions of the processing agent.

As the ion-exchange method, various techniques are known, for example, low temperature ion-exchange, high temperature ion exchange, surface crystallization, dealkalization of the glass surface. However, if the temperature of the glass substrate is excessively elevated beyond a glass transition point (hereinafter will be referred to as Tg) of the glass substrate, the physical property of the glass substrate may be degraded. It is therefore preferable to use the low temperature ion-exchange in which the ion-exchange is performed in a temperature region not exceeding Tg.

The low temperature ion-exchange described above is a technique in which the alkali ions in the glass are replaced by the alkali ions greater in ion radius in a temperature range not higher than Tg so that the compression stress is generated in the surface layer of the glass substrate by an increase in volume of an ion-exchanged part to thereby strengthen the glass surface.

Upon the chemical strengthening process, the processing agent is preferably heated at a heating temperature within a range of 280-660° C., in particular, within a range of 300-400° C. from the viewpoint of Tg, a reaction rate of the ion-exchange, and the like. The glass substrate is preferably contacted with the processing agent for a time period within a range of several hours to several tens hours. Further preferably, the glass substrate is preliminarily heated to the temperature of 100-300° C. for the purpose of preheating before the glass substrate is contacted with the processing agent.

The glass substrate after the chemical strengthening process is subjected to a cooling process, a cleaning process, and so on to become a finished product.

Production of the Magnetic Disk

On the glass substrate obtained according to this invention, at least a magnetic layer is formed. In this manner, the magnetic disk can be manufactured.

A method of forming the magnetic layer is not particularly restricted. For example, deposition by DC magnetron sputtering is suitably used.

As the magnetic layer, use may be made of a ferromagnetic layer such as a Co-based magnetic layer, a CoPt-based magnetic layer, and a CoCr-based magnetic layer. Further, it is preferable to form an appropriate layer, such as an underlayer, between the glass substrate and the magnetic layer in order to improve the magnetic property of the above-mentioned magnetic layer. As the material of the underlayer, an AlRu-based alloy, a Cr-based alloy or the like may be used.

Moreover, it is preferable to form a protection layer on the magnetic layer in order to protect the magnetic disk from the impact of the magnetic head attached to the HDD. As the protection layer, a protection layer containing hard carbon hydride may be preferably used. In addition, it is preferable to form a lubricant layer made of a perfluoropolyether (PFPE) compound or the like on the protection layer because the interference between the magnetic head and the magnetic disk can be relieved.

In order to apply and deposit the lubricant layer on the magnetic disk, for example, dipping may be used.

The magnetic disk according to this invention comprises the glass substrate having the high transverse strength even if the thickness of the substrate is small and, therefore, can be suitably used as a magnetic disk for the mobile HDD. Further, the magnetic disk is suitably used as a magnetic disk for a load/unload (LUL) HDD. In case of the LUL HDD, an impact is applied from the magnetic head attached to the HDD to the magnetic disk during LUL operations. However, the magnetic disk according to this invention and the glass substrate constituting the magnetic disk are high in mechanical strength and superior in shock resistance and, therefore, can be sufficiently resistant against the impact.

Hereinafter, this invention will be explained more in detail with reference to several specific examples.

### FIRST EXAMPLE

Preparation of the Glass Substrate

At first, 500 samples of disc-shaped glass substrates made of an amorphous aluminosilicate glass were prepared. The aluminosilicate glass contained lithium ions as alkali ions and had a composition of 63.6 weight % SiO₂, 14.2 weight % Al₂O₃, 10.4 weight % Na₂O, 5.4 weight % Li₂O, 6.0 weight % ZrO₂, and 0.4 weight % Sb₂O₃.

By precisely mirror-polishing each of the glass substrates, the principal surface of the glass substrate was finished into a mirror surface having a surface roughness of 4.5 nm in Rmax and 0.46 nm in Ra. The value of the surface roughness was calculated in accordance with Japanese Industry Standard (JIS) on the basis of surface profile data obtained by measuring the principal surface of the glass substrate by an atomic force microscope (AFM).

The glass substrate obtained after polishing had a disk diameter of 48 mm, an inner diameter of 12 mm, and a thickness of 0.51 mm.

Chemical Strengthening Process for the Glass Substrate

The glass substrate after polishing was subjected to a series of steps, which will presently be described, to perform the chemical strengthening process by the low temperature ion-exchange.

At first, for a first-stage process, a first processing agent containing sodium nitrate was prepared and heated to 380° C. to be molten. Thus, a molten salt was prepared. The molten salt was sampled and the content of ions was analyzed by the use of the inductively coupled plasma (ICP) technique. As a result, it was found out that the molten salt was a clean molten salt in which alkali ions other than sodium ions, and other positive ions were not substantially detected.

Then, the glass substrate was dipped into the molten salt for two hours. Thus, as the first-stage process, the glass substrate was processed or treated by the sodium ions as the first alkali ions.

Subsequently, for the second-stage process, a second processing agent containing potassium nitrate was prepared and heated to 380° C. to be molten. Thus, the molten salt was produced. Then, in the manner similar to the above-mentioned process using the sodium nitrate, the content of ions was analyzed. As a result of the analysis, it was found out that the molten salt was clean.

Then, the glass substrate was dipped into the molten salt for two hours. Thus, as the second-stage process, the glass substrate was processed or treated by the potassium ions as the second alkali ions.

After the above-mentioned process, the glass substrate was cleaned to obtain the glass substrate subjected to the chemical strengthening process.

Measurement of Physical Property of the Glass Substrate

The surface roughness of the principal surface of the glass substrate obtained as mentioned above was measured by the AFM. As a result, it was found out that the principal surface was a flat and smooth mirror surface having Rmax of 4.5 nm and Ra of 0.45 nm.

Next, the transverse strength was measured for the 500 samples of glass substrates obtained as mentioned above. Herein, the transverse strength was obtained as a load at which the glass substrate was broken when the glass substrate was applied with an increasing load. The result of evaluation is shown in Table 1 which is a list of properties of the glass substrate and the magnetic disk according to this invention.

The result of evaluation shown in Table 1 is given by averages and standard deviations which are calculated from measured values of the transverse strength for these glass substrates obtained in this example.

TABLE 1

| | 1st-stage | | 2nd-stage | | transverse strength | | |
|---|---|---|---|---|---|---|---|
| | process | | process | | (n = 500) | | LUL |
| | sodium | potassium | sodium | potassium | average | standard | durability |
| | nitrate | nitrate | nitrate | nitrate | (kgf) | deviation | test |
| Example 1 | 100 wt % | — | — | 100 wt % | 24.55 | 0.34 | 600,000 |
| | | | | | | | times |
| Example 2 | 60 wt % | 40 wt % | 40 wt % | 60 wt % | 20.21 | 0.36 | 550,000 |
| | | | | | | | times |
| Comparative | — | 100 wt % | — | | 25.48 | 4.04 | 400,000 |
| Example 1 | | | | | | | times |
| Comparative | 40 wt % | 60 wt % | — | | 10.26 | 0.80 | 400,000 |
| Example 2 | | | | | | | times |

Table 1 suggests that, as the transverse strength is higher, the glass substrate is a superior substrate with higher rigidity and higher durability. However, even if the transverse strength is high, the standard deviation being large means significant variation in quality, resulting in reduction in production yield and increase in production cost. Further, if the standard deviation is large, the process capability index (Cpk) is degraded, making it difficult to assure high quality of shipped products.

In this embodiment, the average value of the transverse strength is as high as 24.55 kgf. Notwithstanding, the standard deviation is advantageously as low as 0.34. Thus, it is found out that the glass substrate having sufficient strength can be manufactured with high yield.

Production of the Magnetic Disk

On the glass substrate thus obtained, following layers were successively deposited by DC magnetron sputtering.

At first, on the glass substrate, a seed layer containing an AlRu alloy was formed. Then, on the seed layer, an underlayer containing a CrW alloy was formed. It is noted here that the seed layer serves to reduce the size of magnetic grains of the magnetic layer while the underlayer serves to orient a magnetization easy axis of the magnetic layer in an in-plane direction.

Next, on the underlayer, a ferromagnetic layer containing a CoCrPtTa alloy was deposited as the magnetic layer.

Subsequently, on the magnetic layer, a protection layer containing carbon hydride was formed. The protection layer serves to protect the magnetic layer from the impact of the magnetic head. Then, a lubricant layer containing a PFPE compound was formed thereon by dipping. Through the above-mentioned steps, the magnetic disk was obtained.

(Measurement of the Physical Property Value of the Magnetic Disk)

A glide test by the touch-down height technique was carried out in order to evaluate a magnetic head flying property of the magnetic disk thus obtained. As a result, the touch-down height was equal to 4.5 nm. In other words, it was found out that the magnetic head did not collide with the magnetic disk until the flying height reached 4.5 nm.

Then, an LUL durability test was carried out for the magnetic disk thus obtained. The magnetic disk and a magnetic head having the flying height of 12 nm were mounted to a HDD of the LUL system. Then, LUL operations were continuously and repeatedly carried out. As a result, the magnetic disk could withstand 600,000 times of consecutive LUL operations without any trouble.

This is presumably because the stress profile inside the glass substrate was suitably controlled and, as a result, the durability was increased so that the damage with time was suppressed.

Second Example

In a second example, the chemical strengthening process described in conjunction with the first example was replaced by the following process.

Specifically, as the first processing agent used in the first chemical strengthening process, preparation was made of a processing agent containing sodium nitrate as a major component and obtained by mixing sodium nitrate and potassium nitrate at a weight ratio of 60:40. The processing agent thus prepared was heated and molten to be used as the first processing agent.

Further, as the second processing agent used in the second chemical strengthening process, preparation was made of a processing agent containing potassium nitrate as a major component and obtained by mixing sodium nitrate and potassium nitrate at a weight ratio of 40:60. The processing agent thus prepared was heated and molten to be used as the second processing agent.

Except the above, the glass substrate and the magnetic disk were produced in the manner similar to that described in conjunction with the first example. Then, the measurement was carried out for the glass substrate and the magnetic disk in the manner similar to the first example.

Table 1 collectively shows the transverse strength of the glass substrate thus produced, the standard deviation thereof, and the results of the LUL durability test of the magnetic disk.

In this example, the average values and the standard deviations of the transverse strength of the glass substrate and the results of the LUL durability test of the magnetic disk were slightly inferior as compared with the first example. However, it is found out that the glass substrate as well as the magnetic disk had sufficient strength.

Thus, it has been found out that, in the first and the second examples, the ion-exchange of the surface of the glass substrate was suitably performed while the stress profile inside the glass substrate was controlled within a suitable range. It is noted here that the surface roughness of the glass substrate and the touch-down height of the magnetic disk were similar to those of the first example.

### FIRST COMPARATIVE EXAMPLE

A first comparative example is different from the first example in that, in the chemical strengthening process, only the first-stage process using potassium nitrate as the processing agent was carried out without the second- stage process. Except the above, a glass substrate and a magnetic disk were produced in the similar manner.

For the glass substrate, the transverse strength of the manufactured glass substrate and the standard deviation thereof were measured and calculated. The magnetic disk was subjected to the LUL durability test. The results of measurements and the LUL durability test are shown in Table 1.

From the results in the first comparative example, the following has been found out.

The high transverse strength could be given to the glass substrate by replacing the alkali ions (lithium ions) contained in the glass substrate by the alkali ions (potassium ions) having a greater ion radius. Specifically, the transverse strength of 25.48 kgf was achieved in the first comparative example. However, the standard deviation of the transverse strength among the samples is as high as 4.04, revealing that the transverse strength is widely varied from sample to sample. The result of the LUL durability test was about 400,000 times and was not satisfiable as the magnetic disk. This is presumably because the glass substrate was merely subjected to replacement of the lithium ions in the vicinity of the surface by the potassium ions without controlling the stress profile inside the glass substrate and, as a result, the durability was not increased so that the damage with time was not suppressed.

### SECOND COMPARATIVE EXAMPLE

A second comparative example is different from the first example in that, in the chemical strengthening process, only the first-stage process using the processing agent containing sodium nitrate and potassium nitrate at a weight ratio of 40:60 was carried out without the second-stage process.

Except the above, a glass substrate and a magnetic disk were produced in the similar manner. The transverse strength of the manufactured glass substrate, the standard deviation thereof, and the results of the LUL durability test of the magnetic disk are shown in Table 1.

From the result of the second comparative example, the following is found out.

In order to give the high transverse strength to the glass substrate and to reduce variation thereof, the alkali ions (lithium ions) contained in the glass substrate were replaced by a plurality of species of alkali ions (in the second comparative example, potassium ions and sodium ions) having a greater ion radius. However, the transverse strength of the glass substrate was equal to 10.26 kgf. Thus, the effect of the potassium ions is canceled by the sodium ions. Further, the standard deviation of the transverse strength among the samples was equal to 0.80. Thus, merely by mixing a plurality of species of ions, the variation did not reach a satisfiable level.

Further, the result of the LUL durability test was about 400,000 times and was not satisfiable as the magnetic disk. This is presumably because, only by mixing a plurality of species of ions, the stress profile inside the glass substrate was not controlled so that the durability was not increased and the damage with time was not suppressed.

As described above, according to this invention, in a method of processing a glass substrate for a magnetic disk, the glass substrate containing alkali ions, the glass substrate is processed by the use of a first alkali ion having a first ion radius greater than the smallest ion radius of the smallest alkali ion among the alkali ions contained in the glass substrate. Subsequently, the glass substrate is processed by the use of a second alkali ion having a second ion radius greater than the first ion radius of the first alkali ion.

Through the above-mentioned process, the glass substrate for a magnetic disk has the high transverse strength and the durability against the damage with time.

While this invention has thus far been described in conjunction with a few preferred embodiments or examples thereof, it will be readily possible for those skilled in the art to put this invention into practice in various other manners.

What is claimed is:

1. A method of processing a glass substrate for a magnetic disk, the glass substrate containing alkali ions, the method comprising the steps of:
processing the glass substrate by the use of a first alkali ion having a first ion radius greater than the smallest ion radius of the smallest alkali ion among the alkali ions contained the glass substrate; and
subsequently processing the glass substrate by the use of a second alkali ion having a second ion radius greater than the first ion radius of the first alkali ion.

2. A method as claimed in claim 1, wherein:
a first molten salt containing sodium nitrate is used as a first processing agent for supplying the first alkali ion, and
a second molten salt containing potassium nitrate is used as a second processing agent for supplying the second alkali ion.

3. A method as claimed in claim 1, wherein:
the glass substrate is made of a glass containing 58-75 weight % SiO₂, 5-23 weight % Al₂O₃, 3-10 weight % Li₂O, and 4-13 weight % Na₂O.

4. A method as claimed in claim 1, wherein:
the glass substrate has a thickness within a range of 0.6 mm or less.

5. A method of manufacturing the glass substrate by using the processing method claimed in claim 1.

6. A method as claimed in claim 5, wherein:
at least a magnetic layer is formed on the glass substrate.
